(19) United States
(12) Patent Application Publication
(10) Pub. No.: US 2003/0156991 A1
(43) Pub. Date: Aug. 21, 2003

(54) Optomechanically-responsive materials for use as light-activated actuators and valves

(75) Inventors: Nancy J. Halas, Houston, TX (US); Jennifer West, Houston, TX (US); Scott R. Sershen, Houston, TX (US)

Correspondence Address: CONLEY ROSE, P.C., P. O. BOX 3267, HOUSTON, TX, 77253-3267, US

(73) Assignee: William Marsh Rice University, Houston, TX

(21) Appl. No.: 10/277,852

(22) Filed: Oct. 22, 2002

Related U.S. Application Data
(60) Provisional application No. 60/336,525, filed on Oct. 23, 2001.

(51) Int. Cl. B01L 3/02

(52) U.S. Cl. 422/100

(57) ABSTRACT

The present invention provides a photoactuator comprising a plurality of nanoparticles and a thermally sensitive material. The photoactuator is useful for a variety of applications including macroscale and nanoscale applications. The nanoparticles are in thermal contact with the thermally sensitive material. The nanoparticles are engineered to achieve peak resonance at a given wavelength of light such that upon illumination. Upon illumination of the thermally sensitive material, the nanoparticles convert the light to heat, which is transferred to the thermally sensitive material, inducing a change in volume in the thermally sensitive material. The present invention is useful for actuating devices, especially in microfluidic devices. Methods for making a photoactuator and various embodiments thereof are also provided.

### CROSS-REFERENCE TO RELATED APPLICATIONS

This application claims the benefit of U.S. Provisional Application No. 60/336,525 filed Oct. 23, 2001. The disclosure of that application is incorporated herein by reference.

### STATEMENT REGARDING FEDERALLY SPONSORED RESEARCH OR DEVELOPMENT

This invention was made with government support under Grant No. EEC-0118007 awarded by the National Science Foundation. The United States government has certain rights in the invention.

### BACKGROUND OF THE INVENTION

1. Field of the Invention

The present invention generally relates to particles composed of a nonconducting core coated with a very thin metallic layer, and to methods of using these particles to induce a chemical/mechanical response in certain materials. More particularly, the invention relates to such particles acting as optically-triggered actuators.

2. Description of Related Art

Microfluidics is a technology involving processing fluids or biological materials on a very small scale. Generally, the term microfluidics refers to devices and processes contained on devices that have channels with at least one dimension that is less than 1 mm. Such devices may be used for a variety of applications including, but not limited to, chemical analysis, biochemical analysis, disease identification, microorganism identification, chemical speciation, cell sorting, and a host of other uses for chemical or biochemical testing. This technology may be used to produce air monitors that watch for dangerous chemical agents in public places. Alternatively, microfluidic devices may be used for measuring blood sugar for a diabetes patient.

Microfluidic devices may be designed to accomplish many different functions. Essentially, such devices are microscopic chemical plants or laboratories that have fluid channels for directing minute flows of material to various processing devices and sensors. Pumps, valves, separation devices, and other processing technologies may be included in microfluidic devices for processing and analyzing a fluid or a biological material. The goal of such devices is to be able to continuously and automatically monitor or analyze the fluid or biological material in a portable device without requiring manual laboratory analysis or large scale processing. Research is ongoing to develop microtechnology and processing methods that facilitate the processing capability of microfluidic devices. Better methods and devices are needed for controlling the flow of fluids in microfluidic devices at microscopic levels.

Metal nanoshells are a new type of “nanoparticle” composed of a non-conducting, semiconductor or dielectric core coated with an ultrathin metallic layer. As more fully described in co-owned U.S. Pat. No. 6,344,272, metal nanoshells manifest physical properties that are truly unique. For example, it has been discovered that metal nanoshells possess attractive optical properties similar to metal colloids—i.e., a strong optical absorption and an extremely large and fast third-order nonlinear optical (NLO) polarizability associated with their plasmon resonance. At resonance, dilute solutions of conventional gold colloid possess some of the strongest electronic NLO susceptibilities of any known substance. (Hache, F. et al. App. Phys. 47:347-357 (1988)) However, unlike simple metal colloids, the plasmon resonance frequency of metal nanoshells depends on the relative size of the nanoparticle core and the thickness of the metallic shell (Neeves, A. E. et al. J. Opt. Soc. Am. B6:787 (1989); and Kreibig, U. et al. Optical Properties of Metal Clusters, Springer, N.Y. (1995)). The relative thickness or depth of each particle's constituent layers determines the wavelength of its absorption. Hence, by adjusting the relative core and shell thicknesses, and choice of materials, metal nanoshells can be fabricated that will absorb or scatter light at any wavelength across much of the ultraviolet, visible and infrared range of the electromagnetic spectrum.

Metal nanoshells are described in co-owned U.S. Pat. No. 6,344,272, which discloses compositions and methods for synthesizing unique composite particles having homogeneous structures and defined wavelength absorbance maxima. Metal nanoshells have been used in a variety of applications. For example, co-owned and co-pending U.S. application Ser. No. 09/616,154 describes the use of metal nanoshell particles in methods of in vitro and in vivo sensing of chemical or biochemical analytes employing surface enhanced Raman scattering spectroscopy. Also, co-owned U.S. Pat. No. 6,428,811 describes the use of nanoshells for methods, devices, and compositions for the in vivo localized, photothermally-modulated release of a therapeutic agent, such as a drug. Research is ongoing into the varied uses of nanoshells. Particularly, small scale microfluidic devices require very small machines to control the processes that occur within them. There is a continuing need for machines that can be controlled yet are small enough to operate on a microfluidic device.

### SUMMARY OF THE INVENTION

In a preferred embodiment, the present invention comprises a photoactuator. The photoactuator comprises a plurality of nanoparticles in thermal contact with a thermally sensitive material such that heat from the plurality of nanoparticles is transferred into the thermally sensitive material causing a volume change in the thermally sensitive material. The nanoparticles generate heat when they are illuminated, especially when illuminated with light having a wavelength at or near their peak resonance. Photoactuators of the present invention may be manufactured in macroscale, microscale, or nanoscale. Thus, they are suitable for use on microfluidic devices. The photoactuators of the present invention may be used for a variety of functions including as valves, pumps, or other devices that are actuated by light. These and other embodiments of the present invention will be described in more detail with reference to the following figures.

### BRIEF DESCRIPTION OF THE DRAWINGS

FIG. 1 is a graph showing calculated optical resonances of metal nanoshells having a silica core and a gold shell (suspended in water) over a range of core radius:shell thickness ratios.

FIG. 2 is a graph showing calculated optical resonance wavelength versus the ratio of core radius to shell thickness for metal nanoshells having a silica core and gold shell (in water).

FIG. 3 depict transmission electron microscope images of silica core/gold shell nanoshells during shell growth.

FIG. 4A is a graph showing growth of gold shells on 120 nm diameter silica nanoparticles.

FIG. 4B is similar to FIG. 4A except that it shows the growth of gold shell on 340 nm silica particles.

FIG. 5 is a depiction of hydrogels containing nanoparticles before and after illumination.

FIG. 6 is a graph showing extinction spectra for a silica/gold nanoshell with peak resonance at 830 nm and for a gold colloid at 532 nm.

FIG. 7 is a graph showing the deswelling ratio of nanoshell and gold colloid impregnated hydrogels before and after illumination at 832 nm.

FIG. 8 is a graph showing the deswelling ratio of nanoshell and gold colloid impregnated hydrogels before and after illumination at 532 nm.

FIGS. 9A-B are cross section drawings of a microfluidic device containing a valve of the present invention before and after illumination.

FIGS. 10A-B are cross section drawings of a microfluidic device containing a pair of valves of the present invention acting to direct a flow in each of two different directions.

FIGS. 11A-G are cross section drawings of a microfluidic device containing a pump of the present invention. The drawings follow the sequence of illuminations required to actuate the pump.

FIGS. 12A-C depict a bimorph actuator of the present invention and its various movements.

FIG. 13 depicts an inchworm according to the present invention and the sequential illuminations required to actuate the inchworm.

### DETAILED DESCRIPTION OF PREFERRED EMBODIMENTS

In a preferred embodiment, the present invention provides a photoactuator and methods of making and using photoactuators in a variety of applications. These actuators are particularly useful in microfluidics applications; however, the present invention is not limited to use in microfluidics applications. The photoactuators of the present invention comprise a thermally sensitive material and a plurality of nanoparticles in thermal contact with the thermally sensitive material. The nanoparticles may be distributed within the thermally sensitive material or may be in an adjacent material such that heat generated by the nanoparticles is transmitted into the thermally sensitive material. The nanoparticles are designed to achieve peak resonance under light of a given wavelength. When subjected to light near or at their peak resonance, the nanoparticles resonate and convert the light energy into heat. The heat triggers a response in the thermally sensitive material. The response is generally contraction of the thermally sensitive material to open a void or to otherwise move the material in a desired direction to actuate a valve, pump, or other device. Alternatively, the contraction may result in movement of adjacent material to close a valve or other device. Once the light is removed, the thermally sensitive material again responds, and the movement is reversed.

Metal Nanoshells

The nanoparticles of the present invention may be any of various types of nanoparticles. The term nanoparticle as used in this application encompasses any nanometer or even micrometer scale particle capable of absorbing light and converting it to heat energy. Any of these nanoparticles may be used for the present invention. Metal colloid particles, such as gold colloid, are one example. Preferably, metal nanoshells, or nanoshells, are used. Nanoshells are capable of being engineered to achieve peak resonance over a broad range of wavelengths and, thus, are more flexible from a design standpoint.

The metal nanoshells fabricated as described in co-owned U.S. Pat. No. 6,344,272, incorporated herein by reference, provide the functional structures that are the foundation of the preferred actuators disclosed herein. The nanoshells employed for actuation are preferably particles that range in diameter up to several microns, have a dielectric core, a metallic coating or shell, and a defined core radius:shell thickness ratio. Core diameters of the actuating nanoshells preferably range from about 1 nm to 4 μm or more and shell thicknesses preferably range from about 1 to 100 nm. For any given core and shell materials, the maximum absorbance or scattering wavelength of the particle depends upon the ratio of the thickness (i.e., radius) of the core to the thickness of the shell. Based on the core-radius-to-shell-thickness (core-shell) ratios that are achieved by the referenced synthesis method, nanoshells manifesting plasmon resonances extending from the visible region to approximately 5 μm in the infrared can be readily fabricated. The visible and near-infrared regions of the electromagnetic spectrum are of special interest for biological analysis or sensing applications.

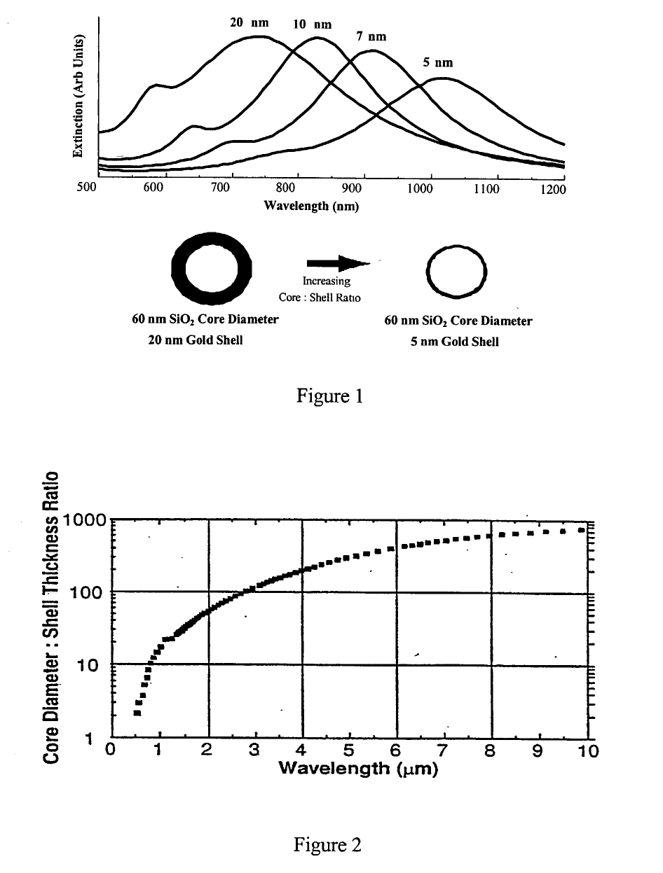

FIG. 1 shows calculated gold nanoshell plasmon resonances for particles of increasing core:shell ratio. A Mie scattering calculation of the nanoshell plasmon resonance wavelength shift is depicted as a function of nanoshell composition for a nanoshell comprising gold layer deposited on a silica core. In this Figure, the core and shell of the nanoparticles are depicted to relative scale directly beneath their corresponding optical resonances. In FIG. 2, a plot of the core:shell ratio versus resonance wavelength for a gold shell/silica core nanoparticle is displayed. By varying the conditions of the metal deposition reaction, the ratio of the thickness of the metal shell to the core radius is varied in a predictable and controlled way. Accordingly, particles can be constructed with core:shell ratios ranging from about 2 to 1000. This large ratio range coupled with control over the core size results in a particle that has a large, frequency-agile absorbance over most of the UV, visible, and infrared regions of the spectrum.

By comparison, the shifts induced in the plasmon resonance of gold colloid by adsorption of molecular species are quite small, typically 10 nm or less. (Kreibig, U. et al. Optical Properties of Metal Clusters, Springer, N.Y. (1995)) The nonlinear optical (NLO) properties of metal nanoshells or nanoshells-constituent materials can be resonantly enhanced by judicious placement of the plasmon resonance at or near the optical wavelengths of interest. Thus, metal nanoshells demonstrate clear potential for optical device applications in the near infrared region, a wavelength range of critical technological importance. The agile “tunability” of the plasmon resonance is a property completely unique to metal nanoshells. In no other molecular or nanoparticle structure can the resonance of the optical absorption and NLO properties be systematically designed over such an extremely wide range of wavelengths.

As described in (Averitt, R. D. et al. Phys. Rev. Lett. 78: 4217-4220 (1997)), the optical properties of metal nanoshells were investigated in detail initially by growing and studying gold-terminated gold sulfide nanoparticles. Quantitative agreement between the Mie scattering theory of FIG. 1 and the optical absorption in Au₂S/Au nanoshells was achieved. As described in co-owned U.S. Pat. No. 6,344,272, a more generalized method for the growth of a uniform metallic layer of nanometer scale thickness onto a dielectric core has been developed. Also, see Oldenburg, S. J. et al. Chem. Phys. Lett 288:243-247 (1998). Briefly described, a preferred process includes growing or obtaining dielectric or semiconductor nanoparticles dispersed in solution. Very small (i.e., 1-2 nm) metal “seed” colloid is attached to the surface of the nanoparticles by molecular linkages. These seed colloids cover the dielectric nanoparticle surfaces with a discontinuous metal colloid layer. Additional metal is then grown onto the “seed” metal colloid adsorbates by chemical reduction in solution.

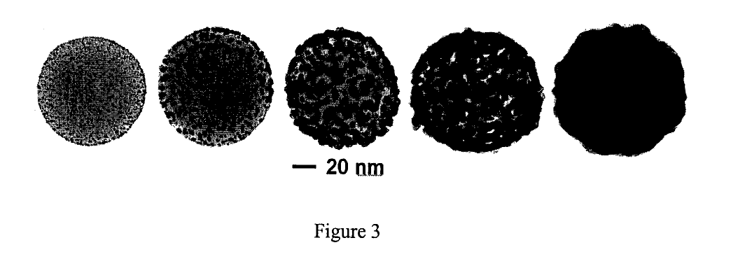

This approach has been successfully used to grow both gold and silver metallic shells onto silica nanoparticles. Various stages in the growth of a gold metallic shell onto a functionalized silica nanoparticle are shown in FIG. 3. The term “functionalized” refers to a linker molecule and the gold colloid attached to the linker. FIG. 3 depicts transmission electron microscope images of silica core/gold shell nanoshells during shell growth. The relative length of 20 nm is shown below the images.

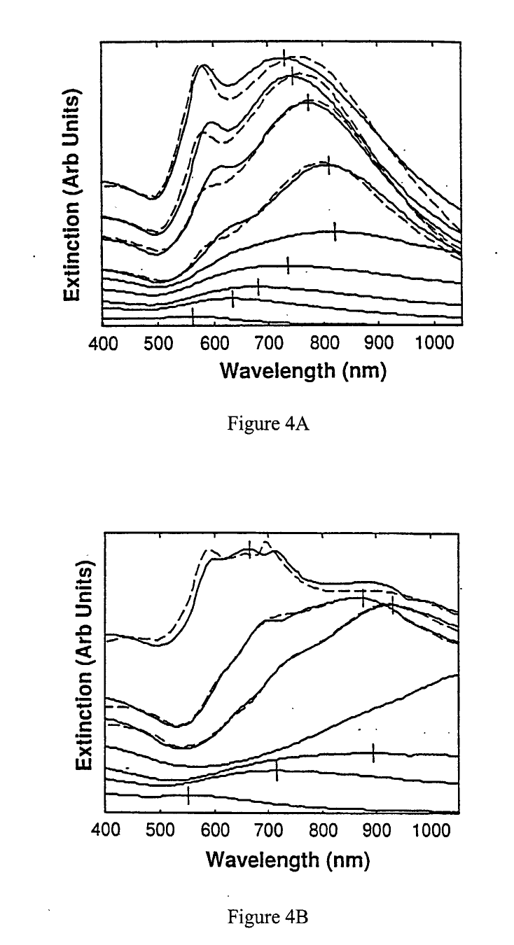

FIGS. 4A-B are graphs showing the optical signature of nanoshell coalescence and growth for two different nanoshell core diameters. FIG. 4A shows growth of gold shell on 120 nm diameter silica nanoparticles. The lower spectral curves follow the evolution of the optical absorption as coalescence of the gold layer progresses. Once the shell is complete, the peak absorbance is shifted to shorter wavelengths. Corresponding theoretical peaks are plotted with dashed lines. FIG. 4B shows the growth of gold shell on 340 nm silica particles. Here the peak shifts are more pronounced, with only the shoulder of the middle curve visible in the range of the instrument employed in the test. Growth of metal nanoshells by this method takes just a few seconds and the yields obtained are greater than 98%. Nanoshells can be easily embedded into films or matrix materials and are stable in a wide range of organic and aqueous solvents.

Although in preferred embodiments the nanoshell particles are spherical in shape, the core may have other shapes such as cubic, cylindrical, or hemispherical. Regardless of the geometry of the core, it is preferred that the particles be homogenous in size and shape in preferred embodiments. Preferably compositions comprising a plurality of metal nanoshells contain particles of substantially uniform diameter ranging up to several microns, depending upon the desired absorbance maximum of the particles. Monodisperse colloidal silica is the preferred core material. These particles can be produced by the base catalyzed reaction of tetraalkoxysilanes by techniques known well to those of skill in the art or obtained from readily available commercial sources. Nearly spherical silica cores having sizes ranging from 10 nm to greater than 4 μm with a variation in particle diameter of only a few percent are preferred.

Suitable dielectric core materials include, but are not limited to, silicon dioxide, gold sulfide, titanium dioxide, polymethyl methacrylate (PMMA), polystyrene, and macromolecules such as dendrimers. The material of the nonconducting layer influences the properties of the particle. For example, if the dielectric constant of the shell layer is larger relative to a dielectric constant of a core, the absorbance maximum of the particle will be blue-shifted relative to a particle having a shell with a lower dielectric constant. The core may also be a combination or a layered combination of dielectric materials such as those listed above.

Suitable metals for forming the shell or outer layer preferably include the noble and coinage metals, but other electrically conductive metals may also be employed, the particular choice depending upon the desired use. More preferred metals that are particularly well suited for use in shells include but are not limited to gold, silver, copper, platinum, palladium, lead, iron or the like. Gold and silver are most preferred. Alloys or non-homogeneous mixtures of such metals may also be used. The shell layer is preferably about 1 to 100 nm thick and coats the outer surface of the core uniformly, or it may partially coat the core with atomic or molecular clusters.

Hydrogels

In accordance with a preferred embodiment of the present invention, nanoparticles are dispersed in a thermally sensitive material. The thermally sensitive material preferably is a hydrogel, membrane, or any material that changes volume in response to a temperature change. Temperature sensitive hydrogels are more preferably used for the present invention. One characteristic of temperature sensitive hydrogels is the presence of a lower critical solution temperature (LCST). The LCST is the temperature at which a material will undergo a reversible phase change. In solution, this temperature would correspond to the transition of an uncrosslinked polymer from an extended coil to a globule. In a crosslinked hydrogel, this phase change results in a collapse of the hydrogel structure upon expulsion of water, with as much as a 90% reduction in the hydrogel volume.

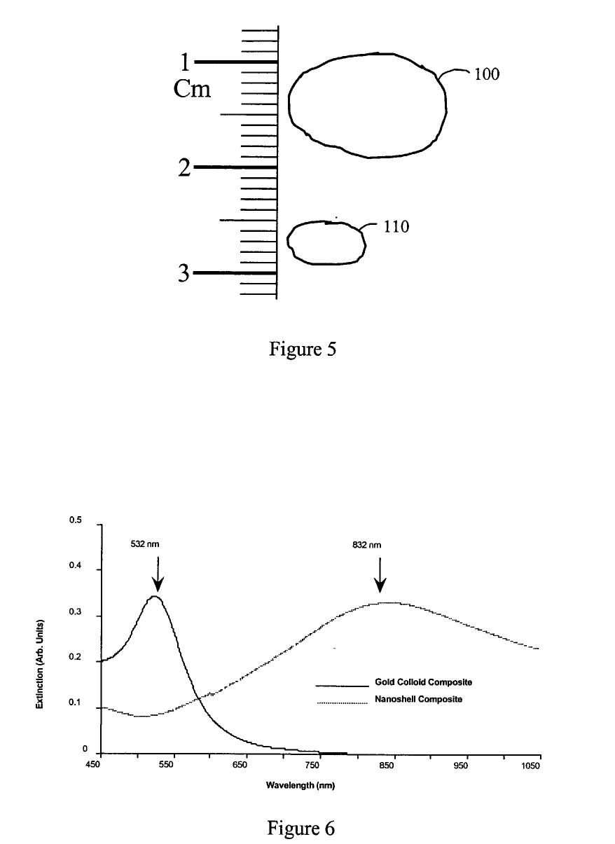

FIG. 5 depicts a hydrogel impregnated with nanoshells before and after exposure to light at the resonant wavelength. The hydrogel before illumination 100 occupies substantially more volume than the hydrogel after illumination 110. The driving force for this phase change is based on interactions between the polymer and the water surrounding the polymer. When the temperature of the hydrogel is held below its LCST, the most thermodynamically stable configuration for the free (non-bulk) water molecules is to remain clustered around the hydrophobic polymer. When the temperature is increased over the LCST, the collapse of the hydrogel is initiated by the movement of the previously clustered water from around the polymer into bulk solution. This movement is prompted by a gain in the entropy of the water as the system adjusts to the increased temperature. Once the water molecules are removed from the polymer, it collapses on itself in order to reduce the exposure of the hydrophobic domains to the bulk water.

N-isopropylacrylamide (NIPAAm) is a preferred, commonly used thermally sensitive polymer with a LCST of 32° C. Copolymers of NIPAAm display LCSTs ranging from 25° C. to 60° C., depending on the identity and concentration of the comonomer. Copolymers of NIPAAm with alkyl methacrylates increase the mechanical properties of the hydrogel and lower the LCST of the hydrogel to around 25° C., allowing cycling between room temperature and slightly elevated temperatures. The inclusion of the hydrophilic acrylamide increases the LCST of the hydrogel. This increases the applicability of the system by placing the LCST above normal physiological levels, thus making it useful under cell culture conditions or in vivo. The copolymers described are preferred depending upon the particular operating environment of a specific application.

Hydrogel Synthesis

The thermally sensitive materials of the present invention preferably comprise polymers of various sorts that substantially change volume with changing temperature. These thermally sensitive materials may be synthesized from monomers as is well known in the art. The synthesis may require initiation with ultraviolet light, or it may proceed automatically upon mixing of the monomer with various other chemical reagents. The polymer and the method of initiation that are preferred depend upon the particular circumstances in which the invention is being used. Hydrogels with different LCSTs, as previously described, may be synthesized depending upon the operating environment of a particular device. Preferably, the thermally sensitive material is a hydrogel. The hydrogel preferably is synthesized in a mixture of nanoparticles such that the nanoparticles are encapsulated within the hydrogel polymer. However, this is not required. The nanoparticles may be contained in a layer adjacent to the thermally sensitive material such that heat from the illuminated nanoparticles can be transferred into the thermally sensitive material (i.e., the thermally sensitive material is in thermal contact with the nanoparticles). The synthesis of hydrogels incorporating nanoparticles may be accomplished in a number of ways as is known to one having ordinary skill in the art, including, but not limited to, redox initiated polymerization, free radical initiated polymerization, thermally initiated polymerization, and photopolymerization. The following example provides but one embodiment of the many potential embodiments of the present invention and is not intended to limit the scope of the present invention.

### EXAMPLE

### Hydrogel Composite Materials

Two nanoparticle formulations were developed with distinct optical resonances at 532 nm and 832 nm. Silica-gold nanoshells that strongly absorbed light at 832 nm were fabricated using the methods described by Oldenburg et al. (U.S. Pat. No. 6,344,272, hereby incorporated by reference). A citrate gold colloid suspension with a peak resonance at 532 nm was made by dissolving 469 mg of sodium citrate in 742 ml of deionized water. The solution was brought to a boil, then 7 ml of 27 μm HAuCl₄ was added. The suspension was removed from a heat source 25 minutes after the addition of the HAuCl₄. The citrate gold suspension was then centrifuged at 3100 RCF for 40 minutes, after which the pellet was collected and stabilized by the addition of 160 μl of thiolated poly(ethylene glycol) (PEG-SH, 5000 molecular weight).

Two hydrogel materials were made as composites of each of these nanoparticle formulations and 1.75 M poly(N-isopropylacrylamide-co-acrylamide). These were formed by mixing the nanoparticle suspension with a monomer solution. A total of 3.3 ml of monomer solution was formed by mixing the two monomers (95 mol % N-isopropylacrylamide, 5 mol % acrylamide) in a round-bottomed flask. The ratio of monomers was chosen to achieve a LCST of approximately 40° C. The crosslinker N,N′-methylenebisacrylamide (MBAAm) was added to the monomer solution at a molar ratio of 1/750 (crosslinker/monomer). The flask was evacuated, and 300 μl of the nanoshell suspension was added along with 11 μl of 1 wt % APS (ammonium persulfate) solution and 2.2 μl TEMED (N,N,N′,N′-tetramethylethylenediamine) (6.6 μM) to initiate the redox reaction that forms the hydrogel. The hydrogel precursor solution was then poured into molds consisting of two glass slides separated by 1.5 mm Teflon spacers. After curing at 30° C. for 2 hours, the hydrogels were removed from the mold and washed in deionized water for 24 hours, after which they were cut into 1 cm diameter disks with a cork borer and dried overnight in a vacuum oven. The hydrogels designed to absorb green light were fabricated in the same manner, except that 600 μl of the gold colloid suspension was introduced at the same time as the initiators.

The near infrared absorbing and green absorbing nanoparticle composite hydrogels were allowed to swell in Tris buffer (pH 7.4, 0.05 M) for 24 hours. The gels were then removed, cleared of excess surface water, weighed, and placed in another glass vial containing Tris buffer at 21°C. Each hydrogel was then irradiated along its vertical axis with a continuous wave diode laser (832 nm, 2.7 W/cm², Coherent, Santa Clara, Calif.) such that the entire hydrogel was within the cross-sectional area of the beam. The hydrogels were weighed at set intervals throughout a 40 minute irradiation period. Prior to weighing, they were dabbed with a damp Kimwipe to remove excess surface water.

The two sets of hydrogels were allowed to swell completely, then transferred to another glass vial containing 21° C. Tris buffer. The same process was performed as described above except that the gels were irradiated with a green laser (Verdi, 532 nm, 1.6 W/cm², Coherent, Santa Clara, Calif.).

Results

With reference to FIG. 6, the extinction spectrum of the silica-gold nanoshells exhibited a peak at approximately 830 nm and a low at 532 nm. The citrate gold colloid exhibited a peak extinction value at approximately 532 nm and no extinction at 832 nm. Each material absorbed light at one of the wavelengths used in these experiments but not the other.

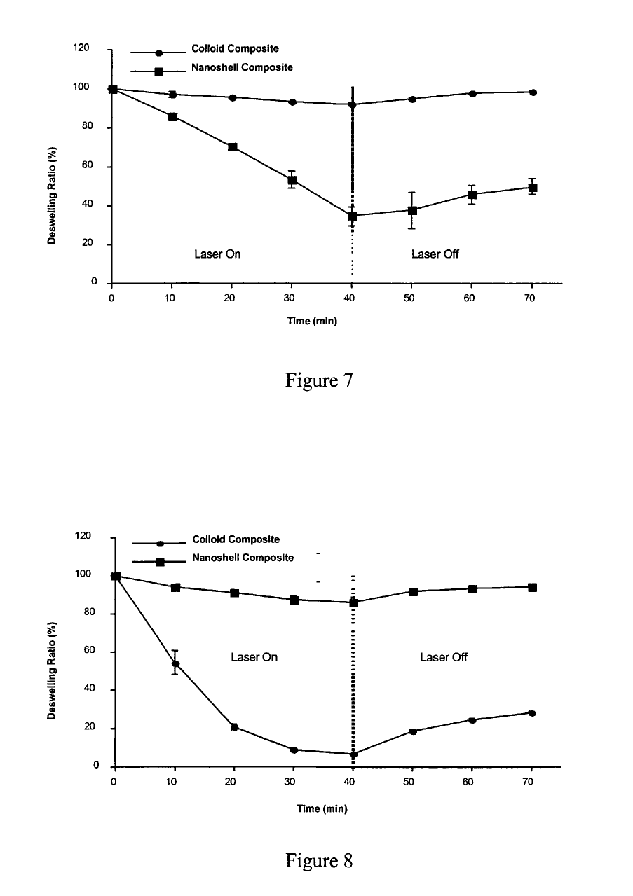

With reference to FIGS. 7 and 8, the degree of collapse of the samples upon illumination is shown. The degree of collapse and swelling of the hydrogels is represented by the deswelling ratio (DSR) as shown in Equation 1. The deswelling ratio is the ratio of the weight at time (t) to the initial weight (at time t=0).

$$DSR = 100 \times ( \frac{Weight ( t )}{Weight ( t = 0 )} ) \qquad ( 1 )$$

With reference to FIG. 7, during near-infrared irradiation, the nanoshell composite collapsed to approximately 30% of its initial weight, while the colloid composite was virtually unaffected by the light. As illustrated in FIG. 8, when 532 nm light was directed at the hydrogels, the opposite effect was observed. The colloid composite collapsed to roughly 7% of its initial weight, while the nanoshell composite showed only a minimal collapse when exposed to 532 nm light. In all cases, the hydrogels began to swell immediately after the irradiation stopped, as shown in FIGS. 7 and 8.

These studies were performed with macroscopic hydrogels, and response time in micro-scaled hydrogels is much faster since the response rate is proportional to the square of the linear dimension.

Applications

In a preferred embodiment, the thermally sensitive materials are combined with nanoparticles as described above to produce controlled motion upon illumination at nanoscale or greater dimensions. The nanoparticles described above are preferably coated with a thermally sensitive polymer or chemical coating of the general thickness range of tens to hundreds of nanometers or more. The coating could be adsorbed onto a substrate, attached to a structure, or suspended in a liquid. Upon illumination with light at a predetermined resonant wavelength, the thermally sensitive material absorbs the heat transferred from the resonating nanoparticles and undergoes a change in volume. Although coating the nanoparticles is preferred, the nanoparticles can simply be in thermal contact with the thermally sensitive material such that heat can be transferred from the nanoparticles into the thermally sensitive material. The motion caused by the change in volume can be used as an active component in many types of sensors, actuators, switches, valves, or other devices requiring motion. Following are some examples of potential uses of the present invention, but these examples do not encompass all of the possible uses of the present invention and are not intended to be limiting.

Although the present invention may be applied in macroscale applications, it has particular advantage for use in nanoscale and microscale applications, such as microfluidic devices. Microfluidic devices encompass a broad array of biochemical and chemical processes that are constructed on a substrate, such as ceramic, silicon, glass, or polymers. These devices have channels that carry fluids as pipes do in a conventional chemical processing facility. These channels may be several micrometers to up to a millimeter in each dimension. Thus, microfluidic devices require very small (i.e., micro scale) equipment if the equipment is to operate on the substrate or within channels on the substrate.

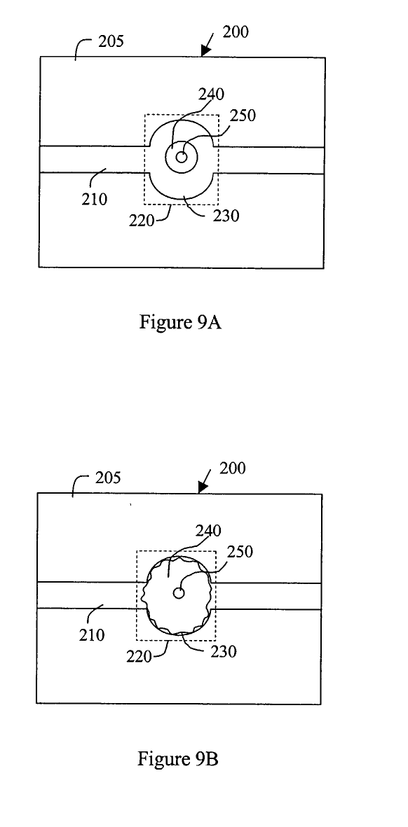

With reference to FIGS. 9A and 9B, in a preferred embodiment the present invention comprises a valve disposed on a microfluidic device. A microfluidic device 200 is constructed of a substrate 205 and has a channel 210 and a valve 220 of the present invention. The valve 220 comprises a void space 230 that may or may not be filled by a thermally responsive material 240. The thermally responsive material 240 is preferably attached to a post 250 to hold it in the void space 230.

The microfluidic device 200 may be used for any purpose. It may perform lab experiments, test for chemicals or biological agents in air, or perform any other function for which microfluidic devices may be used. The substrate 205 may be made of any suitable material such as ceramic, silicon, glass, or any suitable polymer. The microfluidic device 200 may have one or more channels 210 etched or otherwise formed in the substrate 205. The number of channels 210 on microfluidic device 200 is limited only by need and space on the substrate 205. The valve 220 preferably is installed within a channel 210 of the microfluidic device 200. The microfluidic device 200 may have a valve 220 in every channel 210 or only in some channels 210.

If microfluidic device 200 requires more than one valve 220, the valves 220 may be designed to operate in unison or separately depending upon the requirements of the particular application. As previously described, different valves may be composed of different types of nanoparticles that achieve peak resonance at different wavelengths of light. Thus, the different valves may be operated independently. Alternatively, the valves may be composed of similar nanoparticles, such that they achieve peak resonance at the same wavelengths and operate in unison.

The valve 220 preferably comprises an enlarged void space 230 as shown, but valve 220 may be disposed in the channel 210 without any expanded void space 230. The thermally responsive material 240 preferably fills the void space 230 when the valve is closed as shown in FIG. 9B. Thus, flow is prevented through channel 210 because of the thermally responsive material 240 blocking the flow path. Thermally responsive material 240 is a polymer with a plurality of nanoparticles embedded within it. Thermally responsive material 240 may be any medium that responds to heat with a volume change as discussed above. Thermally responsive material 240 is preferably a hydrogel. The nanoparticles may be nanoshells, metal colloid, fullerenes, carbon nanotubes, or any other material that converts light energy into heat. Preferably, the nanoparticles are nanoshells. When illuminated with a light at a wavelength corresponding to or at least near the peak resonance wavelength of the thermally sensitive material 240, the nanoparticles within the thermally sensitive material 240 resonate and heat the thermally sensitive material 240 causing it to shrink. With reference to FIG. 9A, after the thermally sensitive material 240 shrinks, void space 230 is open and flow through the channel 210 may proceed.

The light source may be embedded within microfluidic device 200 or it may be external to the microfluidic device 200. Either method works, and the preference depends upon the particular use of the specific microfluidic device and the space available on the substrate of the particular device.

As flow proceeds, the post 250 holds the thermally sensitive material 240 in place. The post 250 may be constructed of any suitable material, preferably polycarbonate. Preferably the thermally sensitive material 240 is attached to the post 250; however, the post 250 is not necessary. The thermally sensitive material 240 may be attached to the substrate 205, or it may float freely in channel 210. If it floats freely in channel 210, some type of retaining device, such as a screen, may be necessary to prevent the thermally sensitive material 240 from interfering with downstream operations, if any exist.

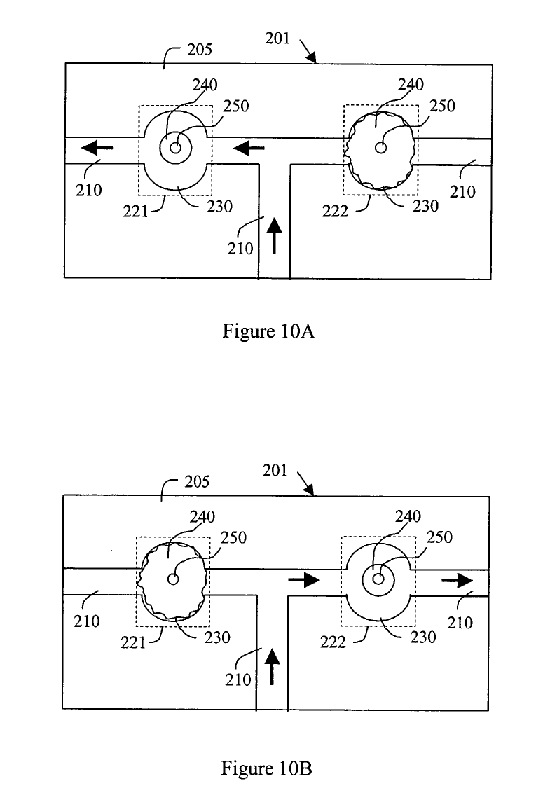

More than one valve may be placed on a substrate, and the separate valves may contain different nanoparticles such that the valves may be operated independently. With reference to FIGS. 10A-B, another microfluidic device 201 is shown. The microfluidic device 201 comprises a substrate 205 and has a plurality of channels 210. The microfluidic device 201 also comprises a first valve 221 and a second valve 222 of the present invention. The combination of the two valves allows flow to be directed in either of two directions or even both directions simultaneously. Similarly, flow can be entirely stopped by closing both valves. The valves 221, 222 comprise a void space 230 that may or may not be filled by a thermally responsive material 240. The thermally responsive material 240 is preferably attached to a post 250 to hold it in the void space 230.

With reference to FIG. 10A, flow passes around the first valve 221, which is open. Flow does not pass around the second valve 222 because it is closed. Alternatively, with reference to FIG. 10B, flow passes around the second valve 222, which is now open, but does not pass around the first valve 221 because it is now closed. First and second valves 221, 222 comprise nanoparticles that resonate at different wavelengths of light such that they can be actuated independently. Both valves 221, 222 may also be opened or closed at the same time. Any number of independently actuated valves may be present on a microfluidic device for directing flow in a common channel or for directing flow in separate channels.

Valve Synthesis

One advantage of the present invention is that the previously described valve 220 may be synthesized within the microfluidic device 200. The ability to synthesize the valve 220 in place greatly increases the usefulness of the present invention and improves the ability to construct more complex microfluidic devices. In particular, the ability to construct a microfluidic device with multiple independently operable valves that are actuated by light allows for more complex operations on a microfluidic device.

Continuing with reference to FIGS. 9A and 9B, a valve 220 may be constructed in a channel 210 of a microfluidic device 200. The valve 220 comprises a void space 230, a thermally sensitive material 240, and a post 250. In the case of constructing valves on the microfluidic device 200, preferably a monomer solution as previously discussed is used containing a crosslinker and a photoinitiator. The monomer solution is injected into the channel 210, or the individual components are injected into the channel 210. The nanoparticles may be mixed within the monomer solution, or they may be injected into the channel 210 separately from the solution. Preferably, the nanoparticles are mixed into the monomer solution prior to injecting the monomer solution into the channel 210 to provide better mixing and distribution of the nanoparticles. A mask is placed over the substrate 205 such that only a desired shape of the thermally sensitive material 240 is open. The opening of the desired shape of the thermally sensitive material 240 is preferably placed over the post 250, such that the thermally sensitive material 240 will be formed on the post 250. An ultraviolet light illuminates the hole in the mask, activating the polymerization reaction and causing the thermally sensitive material 240 to form in the shape of the mask opening. After polymerization is complete, the excess monomer solution and nanoparticles are removed.

In this manner, valves may be synthesized in place on a microfluidic device. Individual valves may be constructed of different materials and different nanoparticles such that they can be actuated independently.

Other Applications

The present invention is not limited to valves in microfluidic devices. As previously discussed, the present invention may be used in macroscale applications for anything requiring light-actuated movement. Further, the present invention may be useful for many other purposes on microscale or nanoscale applications. For example, the present invention may be used to create actuators for many different types of applications in microfluidic devices.

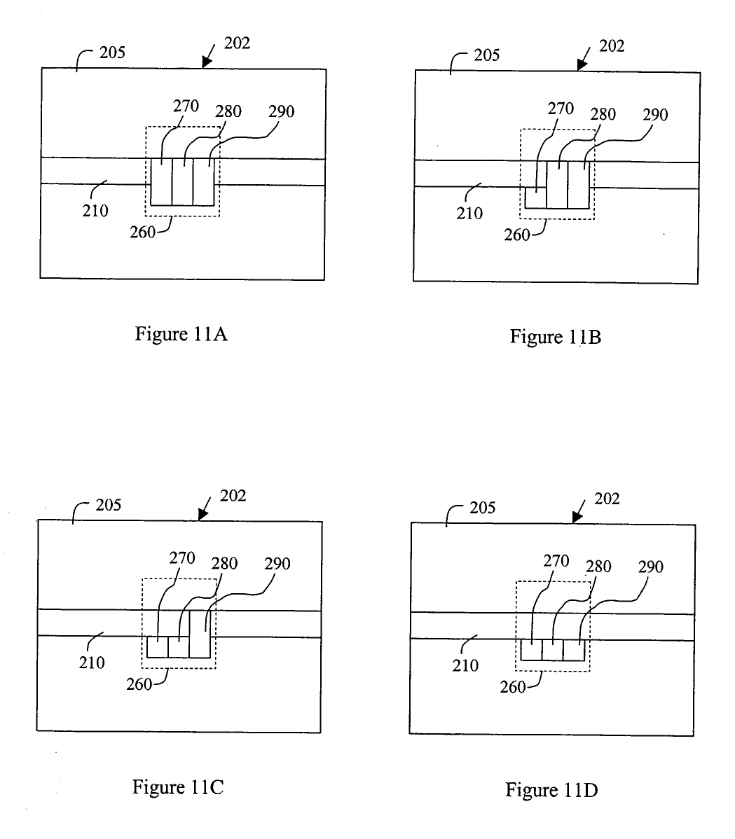

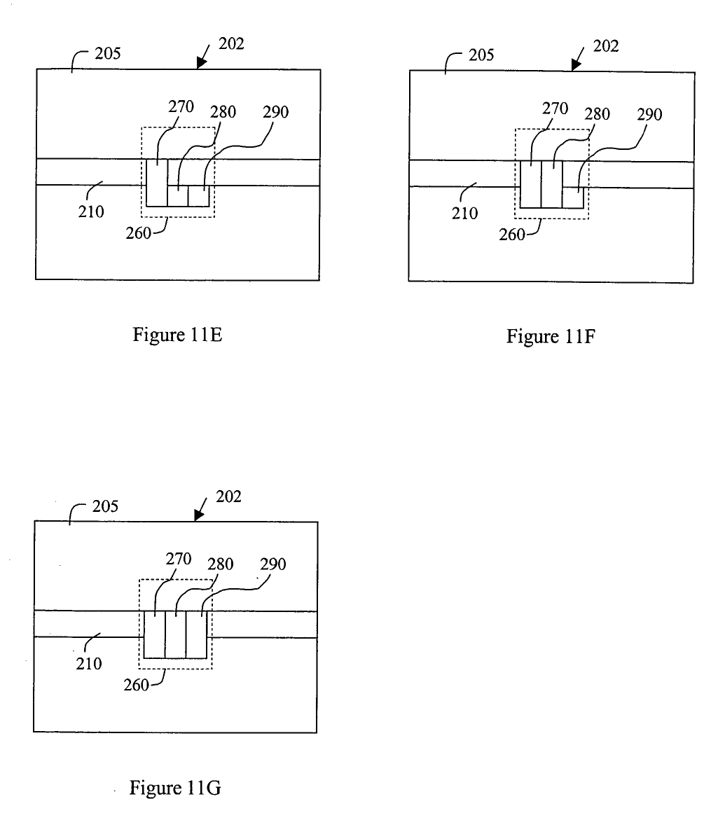

With reference to FIGS. 11A-G, another microfluidic device 202 is depicted. This microfluidic device 202 contains a channel 210 on a substrate 205. It further contains a pump 260 of the present invention. The pump 260 contains a first piston 270, a second piston 280, and a third piston 290 spaced sequentially down the channel 210 such that the pistons 270, 280, 290 are adjacent to each other. The three pistons 270, 280, 290 are made of thermally sensitive materials each containing nanoparticles that achieve peak resonance at different wavelengths. Thus, the three pistons 270, 280, 290 start from a completely expanded position as shown in FIG. 11A. From there, the three pistons 270, 280, 290 proceed through the sequence shown in FIGS. 11A-G. Lights having wavelengths at or near the peak resonance of the pistons 270, 280, 290 are illuminated sequentially. Thus, the three pistons 270, 280, 290 are actuated in sequence causing them to shrink and draw fluid forward in channel 210 until channel 210 is completely open. (Alternatively, the sequence may include leaving the third piston 290 expanded until the first piston 270 has re-expanded to prevent back flow through channel 210.) After channel 210 is completely open (see FIG. 11D), the light corresponding to the first piston 270 is turned off, allowing first piston 270 to expand (see FIG. 11E). Next, second piston 280 is expanded in a similar manner (see FIG. 11F), and third piston 290 is subsequently expanded in a similar manner (see FIG. 11G). The sequential expansion of the pistons drives the fluid in channel 210 forward and creates a pumping motion. The sequence is repeated to achieve a pumping action.

It will be understood that the pump 260 may take many forms. The thermally sensitive material may be linked to an actual piston rather than acting as the piston itself. Alternatively, the pump 260 may comprise one, two, four, five, six, or more pistons as opposed to the three pistons described. Also, devices other than pumps may be actuated or driven in a manner similar to the valves or pumps described above. The present invention is intended to encompass all of those possible variations.

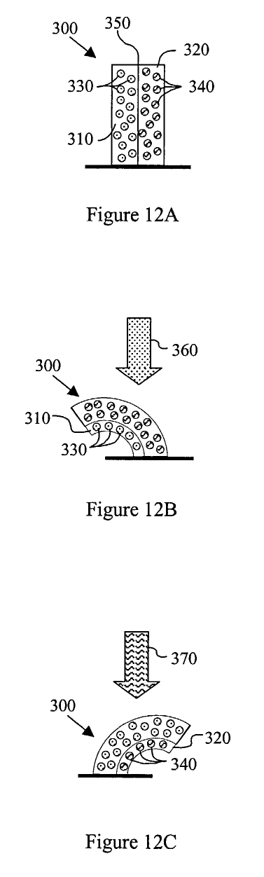

Alternatively, other types of motion may be accomplished with the present invention. For example, bimorph actuators may be created as shown in FIGS. 12A-C. With reference to FIG. 12A, a bimorph actuator 300 is shown. The bimorph actuator 300 contains a first thermally sensitive material 310 and a second thermally sensitive material 320. The first thermally sensitive material 310 contains a first plurality of nanoparticles 330, and the second thermally sensitive material 320 contains a second plurality of nanoparticles 340. The first and second thermally sensitive materials are joined at interface 350. The first and second thermally sensitive materials 310, 320 may be the same or different materials. The first and second pluralities of nanoparticles preferably have different peak resonance wavelengths, such that they can be actuated independently. With reference to FIG. 12B, when the bimorph actuator 300 is illuminated with a light 360 containing a wavelength at or near the peak resonance of the first plurality of nanoparticles 330, the first thermally sensitive material 310 shrinks to create the motion shown. Alternatively, when the bimorph actuator 300 is illuminated with a light 370 containing a wavelength at or near the peak resonance of the second plurality of nanoparticles 340, the second thermally sensitive material 320 shrinks to create the motion depicted in FIG. 12C.

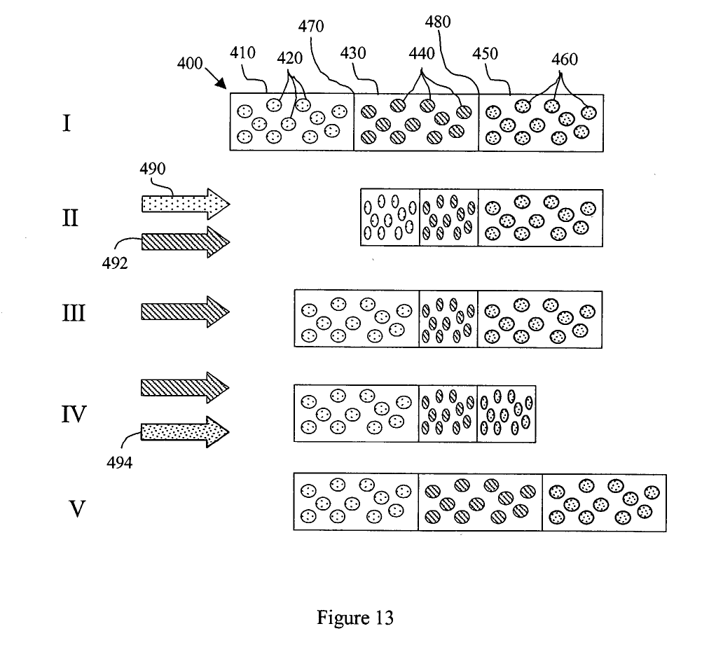

In still another embodiment with reference to FIG. 13, the present invention may take the form of an inchworm. An inchworm 400 has a first segment 410 with a first plurality of nanoparticles 420, a second segment 430 with a second plurality of nanoparticles 440, and a third segment 450 with a third plurality of nanoparticles 460. The first and second segments 410, 430 are connected at first interface 470, and the second and third segments 430, 450 are connected at second interface 480. Thus, a segmented inchworm 400 is formed. The first, second, and third pluralities of nanoparticles 420, 440, 460 preferably are each designed to achieve peak resonance at different wavelengths of light such that the first, second, and third segments 410, 430, 450 can be actuated independently.

FIG. 13 demonstrates movement of the inchworm 400 by actuating the various segments. First, as indicated in Step I, the inchworm 400 lies at rest with all of the segments 410, 430, 450 expanded. Next, with reference to Step II, lights 490, 492 containing wavelengths at or near the peak resonance of the first and second segments 410, 430, respectively, illuminate the inchworm 400 causing the first and second segments 410, 430 to contract. Assuming inchworm 400 is installed in a channel or other structure to which the expanded segments can attach themselves, the third segment 450 will remain fixed while the first and second segments 410, 430 contract and move toward the third segment 450. With reference to Step III, the light 490 containing the proper wavelength for the first segment 410 is then turned off, allowing the first segment 410 to expand and affix itself in its new location. With reference to Step IV, a light 494 having a wavelength at or near the resonant wavelength of the third plurality of nanoparticles 460 illuminates the inchworm 400 causing the third segment 450 to contract and detach itself from the channel or structure. With reference to Step V, in sequential order, the light 492 having a wavelength corresponding to the second plurality of nanoparticles 440 is turned off and the light 494 having a wavelength corresponding to the third plurality of nanoparticles 460 is turned off. The effect of this sequential light removal is to cause the second segment 430 to expand and push the third segment 450 to the right. The third segment 450 is then expanded and affixed in a new location. The process has moved the entire inchworm 400 to the right one step.

As can be seen from the foregoing, the present invention comprises many different embodiments in macroscale, microscale, and even nanoscale. While the preferred embodiments have been shown and described, modifications can be made by one skilled in the art without departing from the spirit and teachings of the invention. The embodiments described herein are exemplary only and are not intended to be limiting. Many variations and modifications of the invention disclosed herein are possible and are within the scope of the invention. For example, while preferred embodiments containing nanoshells as the particular nanoparticle are discussed, it is contemplated that other optically heatable particles can be used, including colloidal metals, organic particles such as carbon black, metal oxides, fullerenes, carbon nanotubes, and other particles that are efficient transformers of optical energy into heat. Accordingly, the scope of the invention is not limited by the description set out above but is only limited by the claims which follow, that scope including all equivalents of the subject matter of the claims. The disclosures of all patents, patent documents, and publications cited herein are incorporated by reference to the extent that they describe pertinent materials or methods not explicitly set forth herein. In method claims, the order of recitation of the steps is not intended to indicate that the scope of the claim is limited to that order of performance.

What is claimed is:

1. A photo actuator comprising:
a plurality of nanoparticles designed to resonate at a predetermined wavelength of light; and
a medium, said plurality of nanoparticles being in thermal contact with said medium and said medium comprising a thermally sensitive material, wherein said medium actuates a device by physical movement of said medium in response to light at said predetermined wavelength.

2. The photoactuator according to claim 1 wherein said nanoparticles comprise nanoshells.

3. The photoactuator according to claim 1 wherein said nanoparticles comprise metal colloid.

4. The photoactuator according to claim 1 wherein said medium is a hydrogel.

5. The photoactuator according to claim 4 wherein said medium comprises a N-isopropylacrylamide polymer.

6. The photoactuator according to claim 1 wherein said device is a valve.

7. The photoactuator according to claim 1 wherein said device is a pump.

8. The photoactuator according to claim 1 wherein said plurality of nanoparticles are dispersed in said medium.

9. A method for making a photoactuator in a void space comprising the steps of:
(a) mixing a plurality of nanoparticles and a monomer, said monomer being capable of forming a thermally sensitive material upon polymerization;
(b) filling said void space with said plurality of nanoparticles and said monomer; and
(c) inducing polymerization of said monomer such tat said monomer polymerizes to form said thermally responsive material within said void space and encompasses at least some of said plurality of nanoparticles.

10. The method according to claim 9 wherein step (a) further comprises mixing a photoinitiator and a crosslinker with said plurality of nanoparticles and said monomer, wherein step (b) further comprises filling said void space with said photoinitiator and said crosslinker, and wherein step (c) comprises illuminating said plurality of nanoparticles, said photoinitiator, said crosslinker, and said monomer with ultraviolet light, such that said monomer polymerizes to form said thermally responsive material and encompasses at least some of said plurality of nanoparticles.

11. The method according to claim 10 wherein said void space comprises a microfluidic channel with a post and wherein step (c) comprises polymerizing said monomer around said post.

12. The method according to claim 11 wherein step (c) further comprises placing a mask over said channel, said mask having a hole in a desired shape of said photoactuator and said ultraviolet light passing through said hole to form said thermally responsive material in said desired shape.

13. The method according to claim 10 wherein step (a) is performed before step (b).

14. The method according to claim 9 wherein said plurality of nanoparticles comprises a plurality of nanoshells.

15. The method according to claim 9 wherein said plurality of nanoparticles comprises metal colloid.

16. The method according to claim 9 wherein said thermally sensitive material comprises a hydrogel.

17. The method according to claim 16 wherein said monomer comprises N-isopropylacrylamide.

18. A microfluidic device comprising:
a substrate;
at least one channel etched into said substrate for directing a flow; and
a first photoactuated device located on said substrate and designed to control said flow.

19. The microfluidic device according to claim 18 wherein said first photoactuated device comprises a plurality of nanoparticles in thermal contact with a thermally responsive medium.

20. The microfluidic device according to claim 19 wherein said plurality of nanoparticles are dispersed in said thermally sensitive medium.

21. The microfluidic device according to claim 19 wherein said plurality of nanoparticles comprise nanoshells.

22. The microfluidic device according to claim 19 wherein said plurality of nanoparticles comprise metal colloid.

23. The microfluidic device according to claim 19 wherein said first photoactuated device comprises a pump.

24. The microfluidic device according to claim 19 wherein said first photoactuated device comprises a valve.

25. The microfluidic device according to claim 19 wherein said thermally sensitive medium comprises a hydrogel.

26. The microfluidic device according to claim 25 wherein said thermally responsive medium comprises a N-isopropylacrylamide polymer.

27. The microfluidic device according to claim 18 further comprising:
a second photoactuated device located on said substrate.

28. The microfluidic device according to claim 27 wherein said first photoactuated device comprises a first plurality of nanoparticles designed to achieve peak resonance at a first wavelength of light and wherein said second photoactuated device comprises a second plurality of nanoparticles designed to achieve peak resonance at a second wavelength of light.

29. The microfluidic device according to claim 28 wherein said first and said second wavelengths are different.

30. The microfluidic device according to claim 28 wherein said first and said second wavelengths are nearly the same.

31. A photoactuated valve comprising:
a thermally responsive material, said thermally responsive material connected to and disposed in a channel; and
a plurality of nanoparticles dispersed in said thermally responsive material, said plurality of nanoparticles being designed to resonate at a predetermined wavelength of light.

32. The photoactuated valve according to claim 31 wherein said thermally responsive material comprises a hydrogel.

33. The photoactuated valve according to claim 32 wherein said thermally responsive material comprises a N-isopropylacrylamide polymer.

34. The photoactuated valve according to claim 31 wherein said channel is disposed on a microfluidic device.

35. The photoactuated valve according to claim 31 wherein said plurality of nanoparticles comprises a plurality of nanoshells.

36. The photoactuated valve according to claim 31 wherein said plurality of nanoparticles comprises a plurality of metal colloid particles.

37. A method for producing a photoactuated valve comprising the steps of:
(a) mixing a plurality of nanoparticles, a crosslinker, a photoinitiator, and a monomer;
(b) injecting said plurality of nanoparticles, said crosslinker, said photoinitiator, and said monomer into a channel; and
(c) illuminating said monomer, said crosslinker, said photoinitiator, and said plurality of nanoparticles with ultraviolet light such that said monomer polymerizes to form a thermally responsive material that encompasses at least some of said plurality of nanoparticles.

38. The method according to claim 37 wherein said plurality of nanoparticles comprises a plurality of metal colloid particles.

39. The method according to claim 37 wherein said plurality of nanoparticles comprises a plurality of nanoshells.

40. The method according to claim 37 wherein said monomer comprises N-isopropylacrylamide.

41. The method according to claim 40 wherein said monomer further comprises acrylamide.

42. The method according to claim 37 wherein said channel is disposed on a microfluidic device.

43. The method according to claim 37 further comprising performing step (a) before step (b).

44. The method according to claim 37 wherein said channel comprises a post and wherein step (c) further comprises illuminating said monomer, said crosslinker, said photoinitiator, and said plurality of nanoparticles with ultraviolet light such that said monomer polymerizes to form a thermally sensitive material that is connected to said post.
